(19) United States
(12) Patent Application Publication
(10) Pub. No.: US 2006/0000146 A1
(43) Pub. Date: Jan. 5, 2006

(54) Windows

(76) Inventors: Francis Xavier Heads, Boondall (AU); Justin Bradley Reid, Boondall (AU)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/167,363

(22) Filed: Jun. 27, 2005

(30) Foreign Application Priority Data
Jul. 1, 2004 (AU) 2004202976

(51) Int. Cl. E06B 7/14

(52) U.S. Cl. 49/408

(57) ABSTRACT

Various improvements to windows are described including a better way to fit window glass to a surround frame which does not result in any unsightly projection and which allows different thicknesses of glass to be accommodated. Another improvement enables larger commercial windows to be fitted to a track from the inside of the building.

### FIELD OF THE INVENTION

This invention is directed to at least one improvement to a window and is particularly directed to improvements in the fitting of window glass to the surround frame, improvements that allow a commercial window to be glazed from the inside to avoid the need for scaffolding which may be required for windows that are glazed from the outside, and various other improvements.

### BACKGROUND ART

One important part of window manufacture/assembly is in the fitting of the glass to the surround frame. Particularly, window glass can be of various types including the thicker noise deadening glass, thinner “ordinary” glass, glass that is opaque, decorative glass and the like.

Conventionally, the glass is fitted into a channel which forms part of the glass frame. The glass frame is ordinarily formed of extruded aluminium although it is also known to provide timber frames etc. The framed glass is then fitted into a window opening as a fixed piece.

Conventionally, it has been necessary to provide different sized channels to accommodate glass of different thicknesses, or to modify the extrusion in some way to accept the thicker glass. Ordinary glass has a thickness of between 2-6 millimetres while noise deadening glass has a thickness of between 6-13 millimetres and typically about 10 millimetres. Thus, if it is desirable to fit noise deadening glass (e.g. a window in a high noise area) it has previously been necessary to use different sized beads up to the limit of the design to accommodate the thicker glass.

It is known to provide a frame formed from two separate sections which are clipped together to define the channel into which the glass is fitted. However, it is usually undesirable to have multiple sections that must be attached together.

Therefore, it would be desirable if it were possible to have a frame formed with a channel or pocket into which glass of various thicknesses could be fitted and which does not require a projecting bead ( which looks unsightly and can be snapped off). In this manner, it would no longer be necessary to have separate frames or multiple sections depending on the thickness of the glass.

Another disadvantage with existing sliding window designs is in how the sliding window is attached to the bottom sill. Typically, the bottom sill (mostly formed from extruded aluminium) contains one or more vertically extending walls which comprise tracks. The top of the walls is rounded and bulbous. A sliding window slides along the top of the wall via a roller. The roller has a lower wheel which rolls over the top of the bulbous portion of the wall. The roller has a housing which sits inside a cavity in the lower horizontal portion of the sliding window. Typically, the wall has a height of between 5-50 millimetres and a thickness which is sufficient to stop the wall from deforming under the weight of the window. For larger sliding windows, it is usual to have two sliding portions (sashes), one behind the other. Each sliding portion (i.e. sliding window) has lower rollers which roll over one of the two vertically extending walls which extend from the sill.

A disadvantage with this conventional arrangement is that under high wind load conditions, it is possible for the sliding window to dislodge from the track. Therefore, there would be an advantage if it were possible to design an arrangement which would make it much more difficult for the sliding window to become dislodged.

Another disadvantage with the conventional arrangement is that if a pair of vertically extending tracks is provided, water and debris can find its way between the pair of tracks and this material is extremely difficult to easily remove. Any buildup of water can cause corrosion and any buildup of debris can cause the windows to slide with more difficulty. Therefore, there would be an advantage if it were possible to provide an arrangement where the build up of water and contamination could be reduced.

Another disadvantage with conventional commercial (higher performance) sliding windows is that the windows need to be fitted from the front of the surround frame. The reason for this is that the bottom sill is provided with a high rear wall which makes it impossible to install the window from the inside of the building. The high rear wall is necessary to provide a measure of support for the window and also to reduce any water from finding its way into the building. While this does not present a great problem for ground level windows, it does present a difficulty when installing windows on aboveground levels. If the window is quite some way above the ground, it is usually necessary to erect scaffolding to enable an installer to install the windows. Alternatively, the installer needs to lean out the window opening to install the window sash from the outside. Therefore, there would be an advantage if it were possible to allow the window to be installed from the inside of the building.

It will be clearly understood that, if a prior art publication is referred to herein, this reference does not constitute an admission that the publication forms part of the common general knowledge in the art in Australia or in any other country.

### OBJECT OF THE INVENTION

It is an object of the invention to provide at least one improvement in the manufacture and design of windows and which may at least partially overcome at least one of the above-mentioned disadvantages or provide a useful or commercial choice.

In one form, the invention resides in a fixed window which has at least one glass pane which has at least one edge extending into a frame, the frame being formed with a channel into which the edge of the glass can pass, the channel having a width which is greater than the width of the thickest glass edge that will extend into the channel, the channel comprising a pair of opposed side walls, one sidewall being provided with a bead member which presses against one side of the glass, the other sidewall being provided with a gasket member that presses against the other side of the glass, the gasket member at least being compressible to accommodate different thicknesses of glass.

In this manner, the frame can be provided with a larger than usual channel to enable thin glass (typically 2-4 millimetres) and thicker glass (typically 6-13 millimetres) to be accommodated in the channel without any change in the design of the frame. Instead of having channels of different size, there is now provided a bead member and a gasket member to hold the glass in the channel.

It is preferred that the frame is formed symmetrically to enable it to be used on left-hand and right-hand jambs. Thus, this means that it is also preferred that the channel is formed symmetrically.

Suitably, the channel is substantially U-shaped and comprises a pair of opposed side walls and a connecting back wall. The channel may have a width of between 15-50 millimetres and preferable between 15-30 mm. The frame will typically be formed from extruded aluminium although no particular limitation is meant thereby.

The channel and particularly the opposed sidewalls of the channel may be provided with a small slot. The slot may function to anchor the bead and the gasket in the channel. It is preferred that each sidewall contains an identical slot to make the frame symmetrical.

The bead may be a co-extruded member and can be fed into the extrusion during the manufacturing process. The bead may comprise a plastics material, a rubber material, an artificial rubber such as neoprene, composite materials and the like. Suitably, the bead has a rear portion that can be held by the small slot on the sidewall to hold the bead in position. The rear portion may comprise a substantially T shaped portion. Suitably, the bead has a front portion that at least partially contacts the glass. The front portion may comprise at least one finger or rib or other type of projection that contacts the glass and that can be bent, squashed or otherwise compressed.

The gasket may comprise an elongate member. The gasket may also be made of plastics material, a rubber material, an artificial rubber such as neoprene, composite materials and the like. The gasket may comprise a rear portion that can be held by the slot in the sidewall. This may comprise a small recess or channel that fits surround one of the walls that defines the slot. However, no particular limitation is meant thereby. It is preferred that the gasket has a design that enables it to be pushed into the channel to sandwich the glass between the gasket and the bead. A forward part of the gasket may be provided with at least one finger or rib or other type of projection that contacts the glass and that can be bent, squashed or otherwise compressed.

Most suitably, the bead is fed into the channel during the manufacturing process. An edge of the glass can then be passed into the channel and the push in gasket is then pushed in place to hold the glass in the channel.

The gasket may have different dimensions to suit glass of different thickness. Alternatively or in addition thereto, the bead may have different dimensions to suit glass of different thickness. Alternatively or in addition thereto, the gasket and/or the bead may be made of a material which can be compressed or otherwise be formed to accommodate glass of different thickness.

In another form, the invention resides in a sliding window assembly which enables the sliding window to be fitted from the inside.

In yet another form, the invention resides in a sliding window which provides a measure of support of the sliding window against inadvertent removal of the window from the track.

Thus, another form of the invention provides a sliding window assembly which comprises a sill, a front sliding window and a rear sliding window, the front sliding window and the rear sliding window comprising a lower horizontal support frame to support the window glass, the sill comprising a front portion facing the outside of the assembly and a rear portion adjacent the inside of the assembly, the rear portion being provided with a vertical track to enable the rear sliding window to slide along this track, the front portion being provided with an elongate channel, the channel having a vertical track to enable the front sliding window to slide along this track, the lower horizontal support frame on the front sliding window extending at least partially into the elongate channel to provide a measure of lateral restraint for the front sliding window.

In this form of the invention, the front sliding window somewhat supported by the channel which is formed on the sill. The track for the front sliding windows is in the channel and the arrangement reduces the possibility of the front sliding window becoming dislodged from the track especially under high negative wind load conditions.

In a variation of this form of the invention, the sill has a lower front portion and a raised rear portion and the track for the rear sliding windows is on the raised rear portion. This elevation of the sill from the front to the rear prevents water from passing to the inside of the assembly. Thus, the high rear wall can be reduced or even eliminated. Consequently, the sliding window can now be fitted from the inside of the building as opposed from the outside. Also, by supporting the front sliding window using the channel, the support provided by the high rear wall is no longer as critical and again this allows the high rear wall to be reduced or removed.

Suitably, the elongate channel is spaced somewhat above the front portion of the sill and typically an upstanding wall is provided to space the elongate channel in this manner. One or more drain openings can be provided in this upstanding wall to quickly and efficiently drain any water. Thus, the arrangements also reduce any retention of water between the vertical tracks.

### BRIEF DESCRIPTION OF THE DRAWINGS

An embodiment of the invention will be described with reference to the following drawings in which:

FIG. 1. Illustrates a section view of a jamb formed with a channel which contains an edge of window glass which is sandwiched between a bead and a gasket.

FIG. 2. Illustrates a split mullion formed of two parts each containing a channel as illustrated in FIG. 1.

FIG. 3. Illustrates another type of mullion each containing a channel as illustrated in FIG. 1.

FIG. 4. Illustrates a narrow frame containing a channel as illustrated in FIG. 1.

FIG. 5. Illustrates a 90° corner frame fitted with a pair of channel containing parts.

FIG. 6. Illustrates a prior art twin sliding window design.

FIG. 7. Illustrates the design of FIG. 6 under high negative wind load conditions.

FIG. 8. Illustrates a twin sliding window design according to an embodiment of the invention.

### BEST MODE

Referring to the drawings and initially to FIG. 1, there is illustrated a jamb 10 formed from extruded aluminium. Although not limiting to the invention, this particular jamb has a dimension of 65 millimetres×40 millimetres. Jamb 10 is symmetrical. Jamb 10 contains a channel 11 comprising a pair of opposed parallel side walls 12, 13 and a rear wall 14. Each sidewall 12, 13 is provided with a small extruded slot 15. A bead 16 is formed from plastics/rubber type material and therefore has a degree of flex. Bead 16 contains a rear portion which has a T shaped cross-section 17 and which fits inside the slot 15 to hold bead 16 in channel 11. Bead 16 also has a front portion comprising a plurality of extending ribs 18 which contact the glass 19.

The other sidewall 12 contains a gasket 20. Gasket 20 has a rear portion comprising a small channel 21 which fits about one of the walls of slot 15 to hold the gasket in place once the gasket has been pushed in. Gasket 20 also has a front portion formed with a plurality of extending ribs 22 which contact the glass 19. Gasket 20 is formed separately and once glass 19 has been pushed into channel 11, gasket 20 is pushed into place to hold the glass relative to jamb 10.

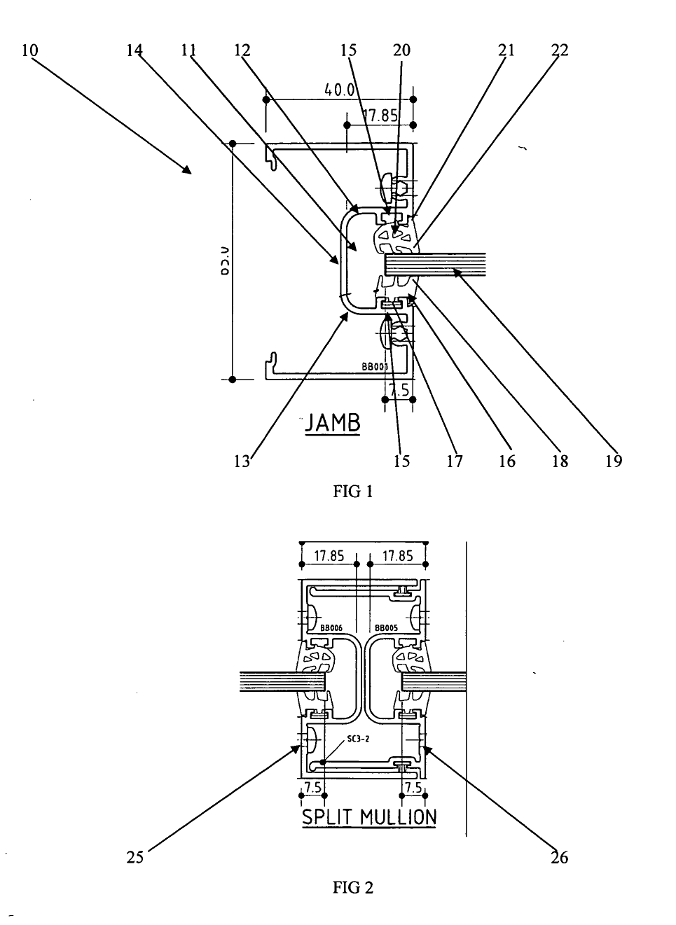

This arrangement is similar with respect to FIGS. 2-5. In FIG. 2, there is illustrated a split mullion which comprises two pieces 25, 26 which slip/slide together to form the mullion. Each piece 25, 26 has a channel which is identical to that described with reference to FIG. 1.

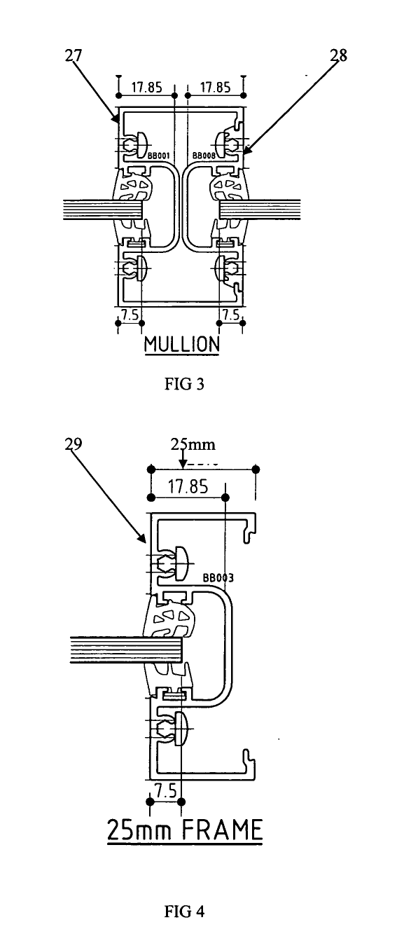

In FIG. 3, there is illustrated another type of mullion which comprises a much larger first piece 27 and a much smaller second piece 28 which fits to first piece 27, and where each piece 27, 28 is formed with a channel as described above.

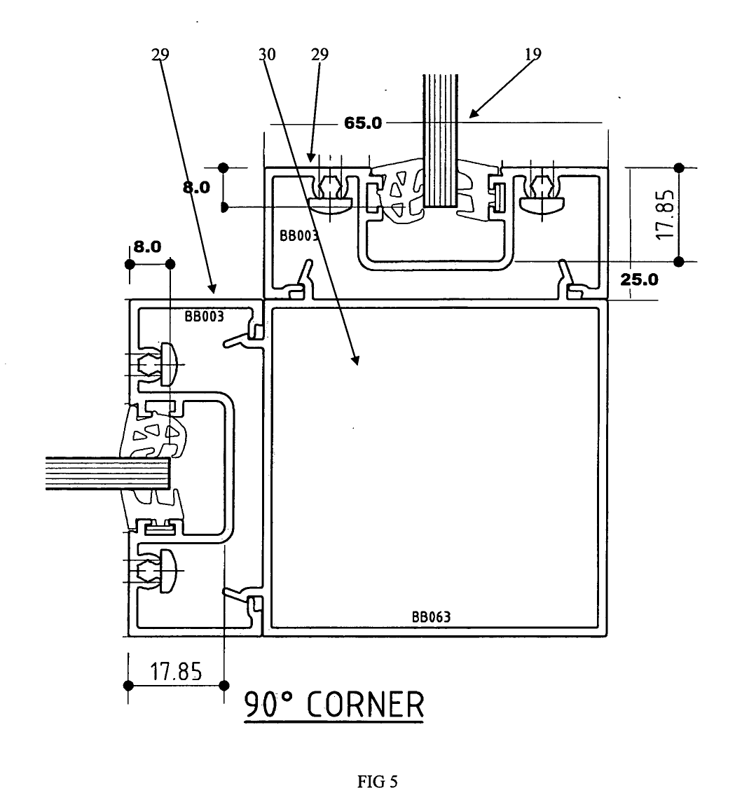

In FIG. 4, there is illustrated a narrow 25 millimeter frame 29 containing a channel as described above.

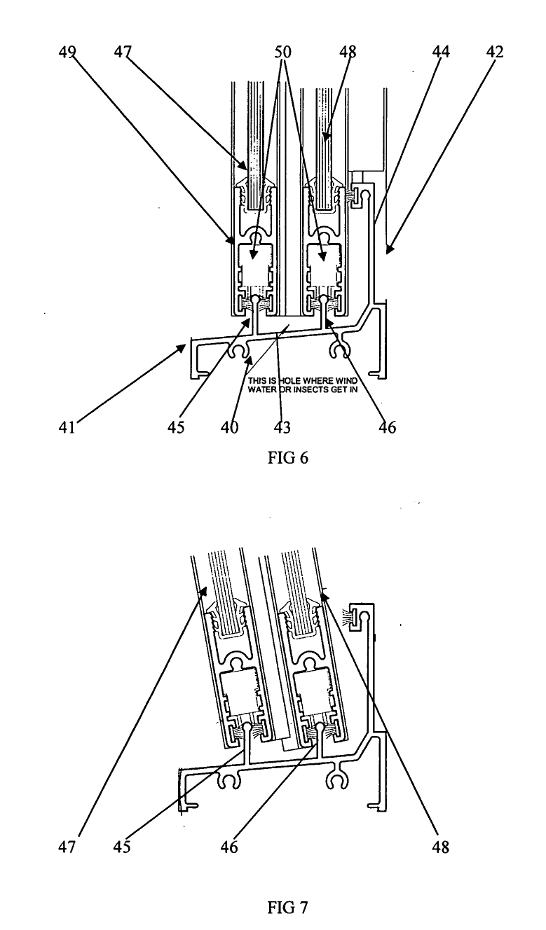

In FIG. 5, there is illustrated a 90 degree corner arrangement. This arrangement comprises a corner piece 30 to which is fitted a pair of 25 millimeter frame pieces 29 (these being the same as illustrated in FIG. 4).

Referring now to FIG. 6-8 there is illustrated another version of the invention which is directed to the ability of the sliding windows to be fitted from the inside of a building and a better support for the front sliding window to reduce the inadvertent removal of this window from the track.

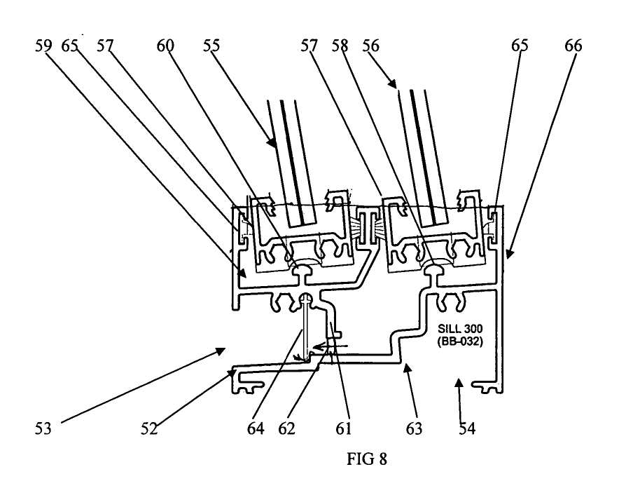

Specifically, FIG. 6-7 show the existing prior art design for commercial windows. In this design there is provided a lower sill 40 which has a front portion 41 and a rear portion 42. The front portion is towards the exterior of the building of the rear portion is towards the interior of the building. The sill is a traditional design and has an only slightly inclined bottom wall 43. Therefore, to prevent water from passing into the inside of the building, there is a requirement to have a rather high rear wall 44. Sill 40 contains a pair of spaced apart vertical tracks 45, 46. A front sliding window (hereinafter called front sash) 47 slides along track 45 and a rear sliding window (hereinafter called rear sash) 48 slides along track 46. Each sash contains a lower horizontal frame portion 49 typically formed from extruded aluminium containing an internal cavity 50 which contains a roller. Thus, the roller slides over track 45 or track 46. As mentioned before, this arrangement is known. There are a number of disadvantages with this arrangement. Firstly, track 45, track 46 and bottom wall 43 form a channel which can fill with water/debris and which cannot be easily cleaned. Another disadvantage is that under high wind loads, the front sash 47 and the rear sash 48 can tilt on the respective tracks, this being illustrated in FIG. 7. It is possible for at least the front sash to pop off its track 45 under such load conditions which is highly undesirable and can be extremely dangerous. If the pressure is reversed and the sashes tilt the other way (not illustrated) the high rear wall 44 provides a measure of support. A disadvantage with the high rear wall 44 is that the sashes cannot be fitted onto the tracks from the inside of the building and can only be fitted from the outside. Thus fitting high rise windows requires scaffolding and scaffolding is also required for any fitting of windows that are above head height.

FIG. 8 illustrates a window design that can at least partially overcome some of the above-mentioned disadvantages. Specifically, there is provided a sill 52 which is a design quite different to the conventional sill design 40 but which still contains a front portion 53 and a rear portion 54. The assembly has a front sliding sash 55 and a rear sliding sash 56. Each sash 55, 56 has a lower horizontal support frame 57 into which a lower edge of the glass can fit. Sill 52 has a rear vertical track 58 to enable the rear sash 56 to slide along the track. The front portion of sill 52 is provided with an elongate channel 59 and the inside of channel 59 is provided with a vertical track 60 to support the front sash 55. Importantly, elongate channel 59 is sized to accommodate at least part of the lower horizontal frame 57 on front sash 55. Thus, the lower part of sash 55 is partially supported by channel 59. Under wind load conditions where the front sash and the rear sash tilt somewhat (see FIG. 8) it can be seen that front sash 55 is protected and supported by channel 59 which is a feature not present in the prior art sash arrangements illustrated in FIG. 6 and FIG. 7.

Sill 52 has a quite pronounced step up design where the rear portion 54 of sill 52 is much higher than the front portion 53 of sill 52. In particular, the step up portion is provided between track 60 and track 58. The outcome is that track 58 is approximately at the same level as track 60 notwithstanding that track 60 sits within channel 59. Thus, sashes 55 and 56 will be level. Another advantage however is that the step up design is very effective in preventing any passage of water across the sill. Thus, the rear wall 44 in the prior art designs (see FIG. 6) can be removed. Consequently, it now becomes possible to fit sashes 55 and 56 from the inside of the building and therefore from the rear of sill 52.

Channel 59 is raised above the “floor” of sill 52 by a generally vertical wall 61. One or more drain slot 62 are provided in wall 61 to drain any water that may be captured between wall 61 and the rear step up portion 63 of sill 52. A small sealing strip 64 is provided which does not entirely seal against water being able to pass through drain slot 62 but which does prevent debris etc from passing into the sill. Also, small sealing and support strips 65 are provided one on rear wall 66 and the other on the inside wall of channel 59 to support the sills.

Throughout the specification and the claims (if present), unless the context requires otherwise, the term “comprise”, or variations such as “comprises” or “comprising”, will be understood to apply the inclusion of the stated integer or group of integers but not the exclusion of any other integer or group of integers.

Throughout the specification and claims (if present), unless the context requires otherwise, the term “substantially” or “about” will be understood to not be limited to the value for the range qualified by the terms.

It should be appreciated that various other changes and modifications can be made to any embodiment described without departing from the spirit and scope of the invention.

We claim:

1. A fixed window which has at least one glass pane which has at least one edge extending into a frame, the frame being formed with a channel into which the edge of the glass can pass, the channel having a width which is greater than the width of the thickest glass edge that will extend into the channel, the channel comprising a pair of opposed side walls, one sidewall being provided with a bead member which presses against one side of the glass, the other sidewall being provided with a gasket member that presses against the other side of the glass, the gasket member at least being compressible to accommodate different thicknesses of glass.

2. The window as claimed in claim 1, wherein the channel is substantially U-shaped and comprises a pair of opposed side walls and a connecting back wall.

3. The window as claimed in claim 2, wherein the channel has a width of between 15-50 millimetres.

4. The window as claimed in claim 2, wherein the opposed sidewalls of the channel are provided with a small slot to anchor the bead and the gasket in the channel.

5. The window as claimed in claim 4, wherein the bead has a rear portion that can be held by the small slot on the sidewall to hold the bead in position.

6. A sliding window assembly which comprises a sill, a front sliding window and a rear sliding window, the front sliding window and the rear sliding window comprising a lower horizontal support frame to support the window glass, the sill comprising a front portion facing the outside of the assembly and a rear portion adjacent the inside of the assembly, the rear portion being provided with a vertical track to enable the rear sliding window to slide along this track, the front portion being provided with an elongate channel,.the channel having a vertical track to enable the front sliding window to slide along this track, the lower horizontal support frame on the front sliding window extending at least partially into the elongate channel to provide a measure of lateral restraint for the front sliding window.

7. The window as claimed in claim 6, wherein the elongate channel is spaced somewhat above the front portion of the sill and an upstanding wall is provided to space the elongate channel in this manner.

8. The window as claimed in claim 7, wherein one or more drain openings are provided in the upstanding wall to drain water.
